(19) United States
(12) Patent Application Publication
(10) Pub. No.: US 2018/0113870 A1
(43) Pub. Date: Apr. 26, 2018

(54) Visual Portfolio Managing Application

(71) Applicant: Maria A. Rogers, Pemberton, NJ (US)

(72) Inventor: Maria A. Rogers, Pemberton, NJ (US)

(21) Appl. No.: 15/361,543

(22) Filed: Nov. 28, 2016

Related U.S. Application Data
(60) Provisional application No. 62/411,361, filed on Oct. 21, 2016.

(51) Int. Cl. G06F 17/30; G06Q 10/10; H04L 29/06

(52) U.S. Cl. CPC G06F 17/30058; H04L 63/083; G06Q 10/1095

(57) ABSTRACT

A process and framework for a content management system that allows the content owner user to retrieve, aggregate, review, tag, search, organize, create, modify, and manage their media content from various online platforms or uploaded sources into one web based application that aggregates the content to create multiple and variant multimedia portfolios. The content owner(s) are provided templates and/or advanced setting to create multimedia portfolios as well as a media tutorial to guide users. The application will integrate third party API (application programmable integration); allow the content owner(s) to control and track viewer access to portfolio(s); set timed send out and expiration date on portfolios; view analytics, statistics and receive feedback.

This present invention is an application framework that allows a system and method to retrieve, review and organize media information from different cloud base platforms into one streamline cloud base platform allowing the content owner to create, manage, control, and send variant and multiple multimedia portfolios.

### REFERENCES CITED [REFERENCED BY]

U.S. Patent Documents

| | | |
|---|---|---|
| 20150324370 | Nov. 12, 2015 | Penrod |
| 20150186133 | Jul. 2, 2015 | Yarra et al. |
| 20050137920 | Jun. 23, 2005 | O'Connor et al. |
| 8,676,690 | Mar. 18, 2014 | Sprague et al. |
| 7,877,516 | Jan. 25, 2011 | Giroux et al. |
| 7,796,640 | Sep. 14, 2010 | Giroux et al. |
| 6,587,480 | Jul. 1, 2003 | Higgins et al |

### BACKGROUND

The claimed invention differs from what currently exists. Many portfolio managing software products are limited to a product specific server library like PhotoBiz*, Pixpa, Google, Vemeo, DropBox, etc. in which the content owner must inputs and manage their media data using the product specific server's limitations. Many individuals and organizations tend to have multiple library servers complicating the efficiency of retrieval, tagging, filtering, organizing and managing of information to create a multimedia portfolio. Individual and organizational websites often have too many or too little images for the viewer to decide whether they like the talent they see or not. Many potential clients request a theme specific images to be sent to them. An example of a request to a home improvement business, “Please send me six pictures of country themed bathroom renovations you have done.” Another example of a request to a stylist for a commercial shoot—“Please send me eight images or video clips of summer themes involving water.”

This visual portfolio application manager will allow the content owner account, who has various cloud server libraries or storage devises, to streamline their multimedia content into one cloud base platform. This platform allows content owner account to be mobile while managing and viewing portfolio(s) using a laptop, tablet, ipad, or smartphone that has internet access and require hardware capabilities. This platform will also allow the viewers mobile access to the portfolio(s) using a laptop, tablet, ipad, or smartphone that has internet access and require hardware capabilities.

Through a process of verification, an account may be created and maintained by the content owner. The visual portfolio application interface provides ease in viewing images, tagging, filtering, organizing and reducing redundant media information to create a gallery of multimedia files. The dashboard, preset templates and advance tutorial also allow for ease in creating variant and multiple media portfolios. The user friendly experience is further enhanced by the ability to preset scheduled portfolio invites with predetermined end date of viewer access (provided permissions are given by content owner) to download images with watermarks. A brief biography, optional splash page and resume page with contact information permits the viewer to engage the content owner's work and follow up with comments and requests.

Created portfolios may be stored for later use, with creation date history, to whom invite was sent, the date sent, and when viewed. This further allows content owner to carefully manage sending of variant or new portfolios. Feedback and data gathered from viewers, internet trends and other account users assist to create a powerful analytic tool for marketing.

Access to visual portfolio manager is by content owner permission via an email invite or link. The content owner has the ability to allow permissions to various individuals and/or organizations to view multiple portfolios and feedback. The viewer has the ability to enlarge, pause or even download an image, if content owner provides permission, for an interactive portfolio experience.

Third party permissions will also allow for administrative uses and content owners to set up a merchant account for products or services.

### SUMMARY

The present invention is a system and method that allows the content owner(s) to retrieve, review and organize their media information from different on line platform into one cloud platform. The media files can then be used to create, manage and organize multiply and variant media portfolios. The media files may include but not limited to digital files that are image, video, music, sound and word processing. The created media portfolios can then be sent out and/or published to various recipients.

The implementation of software code application provides a streamlined process to retrieve, tag, filter, review and organize content owner's multimedia information from different cloud based platforms into one cloud platform to create, store, send and/or publish several and variant multimedia portfolios. The problems with other web based software applications are stated above and are solved by streamlining the various platforms into a single convenient and user-friendly cloud-based platform. Thus the content owner may register for and use this cloud based platform that is coded to integrate a variety of multimedia files into an application that is private and secure.

Another aspect to the invention is the inclusion of a dashboard that enables the content owner the ability to manage and control the settings of the application. Through the dashboard, the content owner is able to access other on line accounts to streamline them into one online platform. The coded application allows the content owner to view, accept or reject multimedia files from other online accounts to create a gallery for tagging, filtering and search multimedia files. Using preset templates or advanced settings on the dashboard, portfolio(s) can easily be created by dropping and dragging chosen media files. The newly created portfolio may be labeled, saved for later use or deleted. The content owner may easily view created portfolio(s) with information on date created, who invite was sent to, date viewed, who viewed and the date set for permission to expire. The coded application enables the content owner to upload their logo, input contact information and a short biography, provide a feedback page as well as social media and merchant links. Private information inputted may be include in the multimedia portfolio. The application also enables the content owner to view and control the invitation(s) send out date of portfolio to viewers as well as control the viewing time period of the viewer. Example, a viewer is sent an invite to view a visual portfolio on Aug. 2, 2016. The content owner also has set the expire date for viewing the portfolio to be Sep. 2, 2016. So after Sep. 2, 2016, the viewer will not have access to the portfolio because the permission has been denied by user/content owner. The user/content owner may allow or restrict permissions to download images with watermarks.

Another aspect to the invention is the inclusion of interactive tutorials to guide the content owner. The tutorials provide interactive visuals guides that are present here but not limited to 1—retrieving your password 2—exploring the advantages of using this stream lined platform 3—using the dashboard 4—integrating content owner's various cloud accounts into their registered account 5—uploading media files from hardware devices 6—tagging media 7-using templates to create a portfolio 8—creating, storing and managing portfolios 9—sending invites or links to view portfolio(s) 10—using the help desk.

The visual portfolio application may be used by an individual, organization or groups of individuals. The preferred audience of content owner are individuals seeking to create portfolios for resume submission, business contractors seeking to visually present their skills, students to present works of achievements and organizations to showcase talents and products. The visual portfolio manager is a viable tool for individuals and organization to market works of art, talent, technical skills, products and services to potential school admissions, employers and team building organization.

A musician may use this portfolio application to showcase technical skills playing various genre for a music label or band to view. A photographer or agency may use the visual portfolio application to present technical skills of lighting and presentation based on themes or subject. There are also applications for educational and training uses. A student, educator or organization may use this platform to show a multimedia progression of work such as a long term science experiment; progressing in language skills or learned skills. Other educational uses may involve but not limited to, short instructional videos of teaching skills demonstrations, classroom management demonstrations, and foreign language skills demonstrations.

### BRIEF DESCRIPTION OF DRAWING

FIG. 1 is a diagram of the flow chart illustrating the system of one cloud based platform.

FIG. 2A is conceptual illustration of the dashboard framework in which a content owner account has ability to input content, view and manage settings.

FIG. 2B is conceptual illustration of the gallery in the dashboard framework in which a content owner account can securely retrieve, tag, filter, search and organize their multimedia images.

FIG. 3 is conceptual illustration of advance setting for portfolio templates.

FIG. 4 is conceptual illustration of portfolio with content owner's business name and contact information.

FIG. 5 is conceptual illustration of portfolio embed for web page, social media or email.

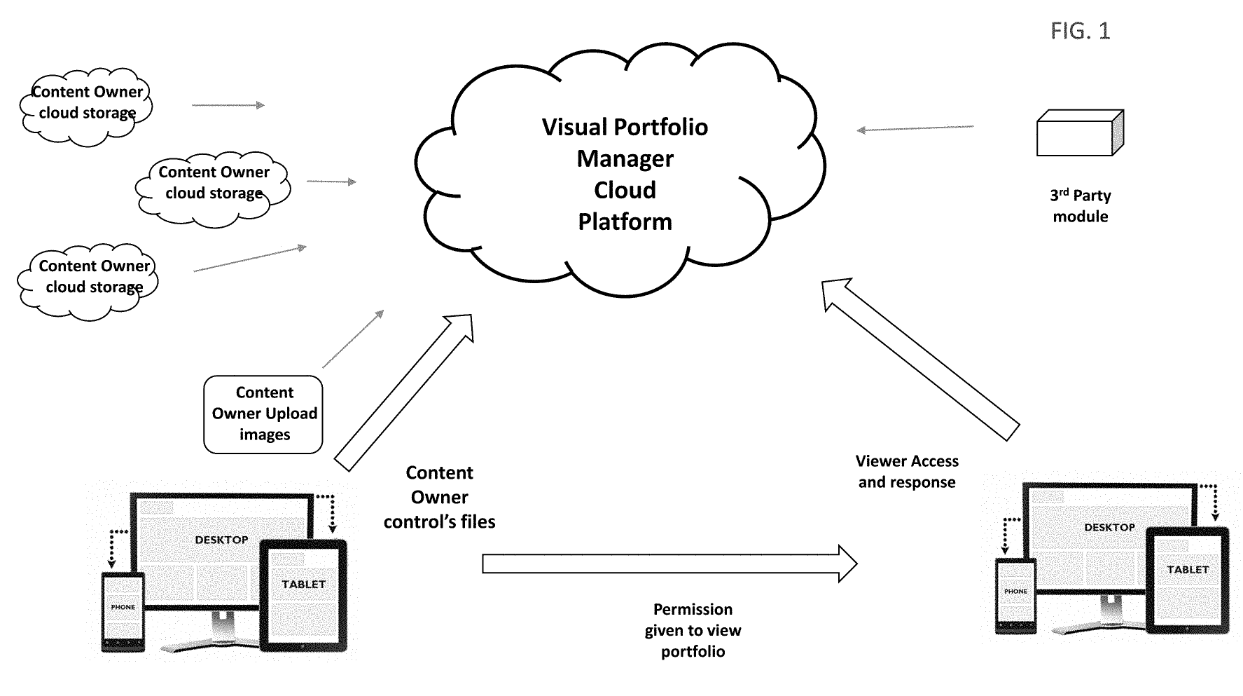

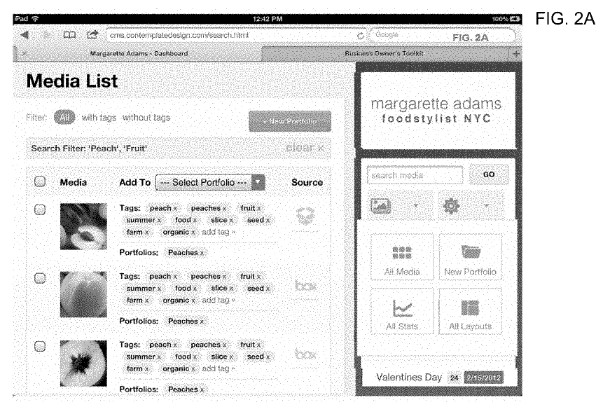

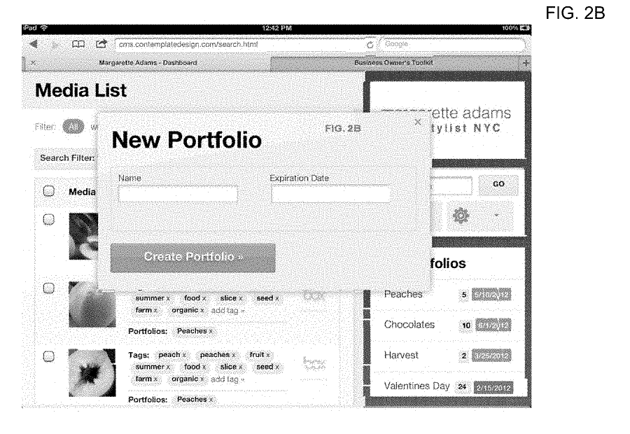

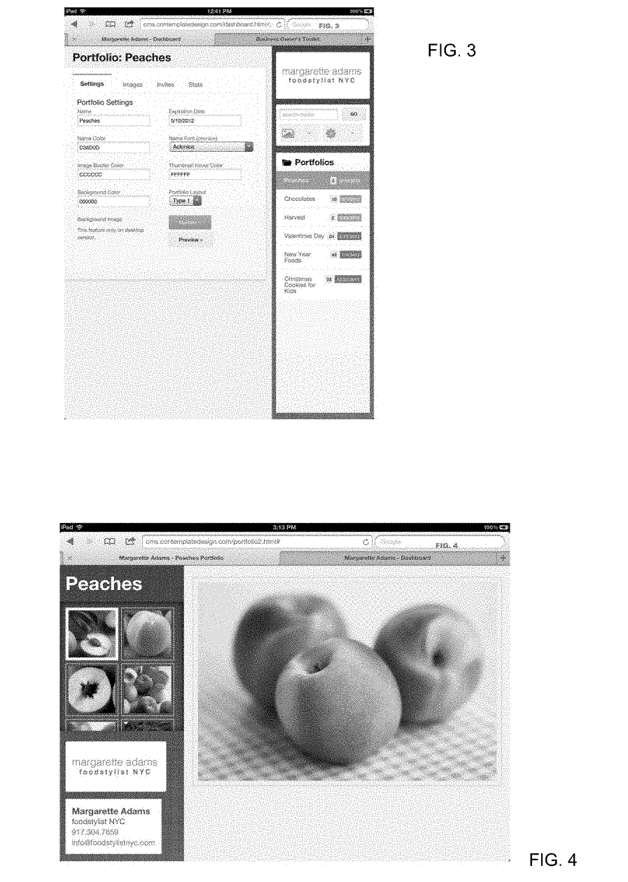

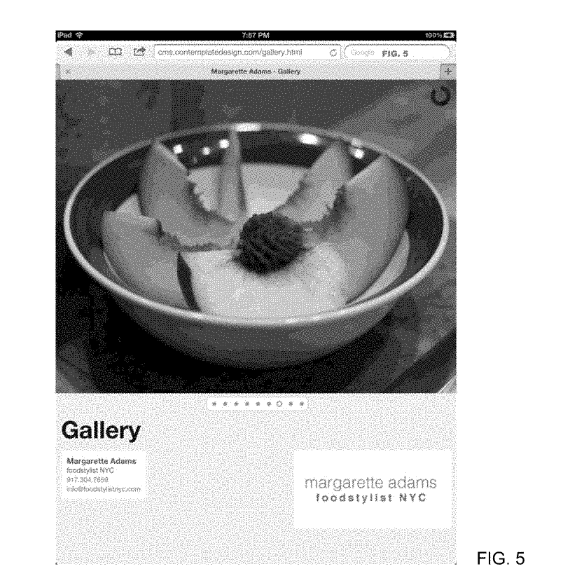

The disclosures, examples and conceptual illustration of the information presented are intended to be considered as examples in spirit only, to present and support the inventions claims.

1. Cloud based visual portfolio management application method, comprising: a. the cloud based executable codes allows each content owner account a secure framework to log into several cloud based media storage application from one cloud based platform; b. the cloud based platform allows each content owner account to upload multimedia images from hardware storage device(s); c. the visual portfolio management application is executable from a plurality of hardware devices via internet access; d. visual portfolio management application allows a framework for each content owner account to securely retrieve, aggregate, tag, filter, search, and organize their multimedia images through a dashboard; e. the framework of the visual portfolio management application allows each content owner account to create, modify, organize and manage a plurality of variant customizable portfolios; f. the executable codes allow the content owner account to control access of viewer(s) to multimedia portfolio(s) via invites and/or links; provide content owner(s) means to schedule timed invites/links to viewers via internet; provide content owner account(s) means to schedule termination of viewers invites/links; aggregate data on viewing history, feedback and other cloud sources; g. allow for third party API application programmable integration.

2. The visual portfolio management application of claim 1, wherein said executable codes allows each content owner to create an identifiable account on a cloud based platform for their media data.

3. The visual portfolio management application of claim 1, wherein said executable codes allows a framework for each content owner a means to access their specific information on a cloud based server by inputting a specific executable code.

4. The visual portfolio management application of claim 1, wherein said executable codes allows each content owner to view multiple media storage cloud platforms in one streamline aggregated multimedia cloud platform.

5. The visual portfolio management application of claim 4, wherein said executable codes allows each content owner to view their media storage data from several cloud platforms to include: digital, audio and video platform sources.

6. The visual portfolio management application of claim 1, wherein said executable codes allows each content owner to upload multimedia data to include: digital, audio and video information into one streamline cloud platform.

7. The visual portfolio management application of claim 1, wherein said executable codes allows each content owner to create a gallery in the dashboard from multimedia data uploaded or from other cloud storage platforms into one streamline cloud platform

8. The visual portfolio management application of claim 1, wherein said executable codes allows each content owner to create, preview, modify and label customizable media portfolio(s) using preset templates and/or advance settings.

9. The visual portfolio management application of claim 1, wherein said executable codes allows each content owner to input personal and professional content.

10. The visual portfolio management application of claim 1, wherein said executable codes allows each content owner to organize and manage a plurality of variant portfolios.

11. The visual portfolio management application of claim 1, wherein said executable codes allows each content owner a means to invite selected viewers access to portfolio(s).

12. The visual portfolio management application of claim 10, wherein said executable codes allows each content owner the ability to allow or restrict selected viewers to media portfolio(s).

13. The visual portfolio management application of claim 10, wherein said executable codes allows each content owner to preset scheduled timed invites/links out to multiply selected viewers.

14. The visual portfolio management application of claim 1, wherein said executable codes allows each content owner to set timed viewing parameters of selected viewers to media portfolio(s).

15. The visual portfolio management application of claim 4, wherein said executable codes allows each content owner to view content from various platforms to accept or reject any redundant images for portfolio s).

16. The visual portfolio management application of claim 10, wherein said executable codes allows each content owner to view history of selected viewers to media portfolio(s).

17. The visual portfolio management application of claim 11, wherein said executable codes allows each content owner to provide selected viewers permission to download media portfolio(s).

18. The visual portfolio management application of claim 1, where in executable codes of algorithms to find, gather correlation and/or patterns among selected viewers and other content owner accounts an analytic report of viewership.

19. The visual portfolio management application of claim 18, where in executable codes of algorithms to aggregate, gather correlation and/or patterns among internet viewers.

20. The visual portfolio management application is executable from a plurality of hardware devices via internet access.

21. The visual portfolio management application of claim 1, where in executable codes allows each content owner to provide embed links for merchant, social media and web site to account.

22. The visual portfolio management application of claim 1, wherein executable codes allow cloud management administrative abilities to updates for network security, new templates and products for the improvement of the content owner experience.

23. The method of claim 1, consists of steps to verify the identity of each content owner to account created.

24. The method of claim 1, wherein said system allows the content owner to retrieve, aggregate, search and organize their multimedia images in a gallery by means of executable codes of algorithms to locate redundant media.

25. The method of claim 3, wherein said executable code provides the content owner steps to verify the identity of each content owner to account and allow content owner to retrieve or reset password.

26. The method of claim 4, wherein said executable code provides steps for each content owner account to access other third party cloud platform account(s) and retrieve their multimedia information.

27. The method of claim 6, consist of automatic creation date stamping of created media portfolio.

28. The method of claim 7, consist of executable codes that automatically adjust multimedia to correct size and/or format.

29. The method of claim 9, consists of executable codes that allows the content owner account to input text, media information and logo into a formatted dashboard template.

30. The method of claim 9, consists of codes that allows the content owner the ability to control access to personal and professional content inputted in dashboard template.

31. The method of claim 11, wherein said executable code allows steps for content owner access to their account from any devices that meet executable command requirements and has internet access.

32. The method of claim 11, consists of steps to verify the identity of each selected viewer given permission to view media portfolio(s).

33. The method of claim 11, consists of steps that allow content owner to provide embed codes and links to selected viewer to view media portfolio(s).

34. The method of claim 11, consist of automatic date stamping of selected viewer history of media portfolio(s).

35. The method of claim 12, consists of automatic watermark stamping of downloaded media portfolio of images by selected viewer.

36. The method of claim 18, consists of formatted code that allows the selected viewers to send comments to content owner's account on portfolio content.

37. The method of claim 20, wherein said executable code allows the selected viewers to access portfolio(s) from varies hardware devices that meet executable command requirements and has internet access.

38. The method of claim 26, wherein said executable code provides allows content owner account to see the third party cloud platform account(s) in which multimedia information was retrieved.
